(19) United States
(12) Patent Application Publication
(10) Pub. No.: US 2026/0126520 A1
(43) Pub. Date: May 7, 2026

(54) SENSOR COVER

(71) Applicants: Hyundai Motor Company, Seoul (KR); Kia Corporation, Seoul (KR); ECOPLASTIC CORPORATION, Gyeongju-si (KR)

(72) Inventors: Hong Heui LEE, Hwaseong-si (KR); Dong Ha KIM, Hwaseong-si (KR); Jin Young YOON, Hwaseong-si (KR); Wan Ho SON, Gunpo-si (KR); Eung Joo KIM, Gyeongju-si (KR); Tai Won KIM, Gyeongju-si (KR)

(21) Appl. No.: 19/207,070

(22) Filed: May 13, 2025

(30) Foreign Application Priority Data
Nov. 5, 2024 (KR) 10-2024-0154826

(51) Int. Cl. G01S 7/40; G01K 1/02; G01S 7/02; G01S 13/931

(52) U.S. Cl. CPC G01S 7/4047; G01K 1/026; G01S 7/027; G01S 13/931

(57) ABSTRACT

A sensor cover includes a base layer, a cover layer disposed on the base layer and made of a self-healing material, and a heating film disposed between the base layer and the cover layer and configured to generate heat. The base layer and the cover layer are integrated with each other through a double injection molding process.

### CROSS-REFERENCE TO RELATED APPLICATION

This application claims, under 35 U.S.C. § 119(a), the benefit of priority from Korean Patent Application No. 10-2024-0154826, filed on Nov. 5, 2024, the entire contents of which are incorporated herein by reference.

### TECHNICAL FIELD

The present disclosure relates to a vehicle sensor cover.

### BACKGROUND

A vehicle may include heating wires arranged at various locations of the vehicle for various purposes. For example, heating wires may be installed on the mirror or rear window of a vehicle to remove snow, frost, and the like from the surface thereof, thereby securing visibility of a driver. As another example, heating wires may be installed in a seat or a steering wheel of a vehicle, which may quickly warm a driver or an occupant in the vehicle in chilly weather.

In some cases, vehicles may include environmental sensors configured to monitor and analyze environmental conditions, such as a radar sensor, a LiDAR sensor, and a camera to assist safe driving of a vehicle or enable autonomous driving of a vehicle through detection of the surrounding environment. Performance of an environmental sensor may deteriorate due to foreign substances, snow, frost, and the like attached to the surface of the environmental sensor. In order to secure performance of the environmental sensor, heating wires may be applied to a device adapted to protect an environmental sensor, or the heating wires may be directly applied to an environmental sensor.

### SUMMARY

The present disclosure describes a sensor cover configured to protect an environmental sensor of a vehicle.

For example, the present disclosure describes a sensor cover configured to enable an environmental sensor of a vehicle to be normally operated in a low-temperature environment.

According to one aspect of the subject matter described in this application, a sensor cover includes a base layer, a cover layer disposed on the base layer and formed of a self-healing material, the cover layer being integrated with the base layer, and a heating film disposed between the base layer and the cover layer, the heating film being configured to generate heat.

Implementations according to this aspect can include one or more of the following features. For example, each of the base layer and the cover layer can be made of a material configured to transmit radio waves therethrough. In some examples, the base layer is made of polycarbonate, and the cover layer is made of polyurethane. In some examples, the base layer can further include glass fiber.

In some implementations, a thickness of the base layer is 2.34 to 2.86 millimeters (mm). In some implementations, a thickness of the cover layer can be 0.4 to 1.0 mm.

In some implementations, the cover layer can be made of soft polyurethane or made of soft polyurethane and hard polyurethane. In some implementations, the heating film can include a film layer and a plurality of heating wires disposed on the film layer and spaced apart from one another by a preset interval therebetween. For instance, the preset interval can be 5 to 7 millimeters. In some examples, the film layer can be made of polyethylene terephthalate (PET), and the plurality of heating wires are made of copper and silver. In some examples, a thickness of each of the plurality of heating wires is 70 to 90 micrometers.

In some implementations, the heating film can further include a connector connected to the heating film and configured to supply an electrical signal to the heating film, the connector being disposed at a side surface of the sensor cover.

According to another aspect, a vehicle includes a radar sensor and a sensor cover that covers at least a portion of the radar sensor. The sensor cover includes a base layer, a cover layer disposed on the base layer and formed of a self-healing material, and a heating film disposed between the base layer and the cover layer, the heating film being configured to generate heat.

Implementations according to this aspect can include one or more of the following features. For example, the vehicle can include an outside temperature sensor configured to detect an outside temperature, a cover temperature sensor configured to measure a temperature of the sensor cover, and a controller configured to receive information from the outside temperature sensor, the cover temperature sensor, and the radar sensor, the controller being configured to control an operation of the heating film based on the collected information.

In some implementations, the controller can be configured to receive the outside temperature from the outside temperature sensor while the vehicle is in operation, and operate the heating film in response to the outside temperature being below 0 degrees Celsius. In some examples, the controller can be further configured to stop the operation of the heating film in response to the temperature of the sensor cover being greater than or equal to a preset temperature.

In some implementations, the controller can be configured to determine whether the radar sensor performs a normal operation while the vehicle is in operation, and operate the heating film based on determining that the radar sensor performs an abnormal operation while the vehicle is in operation. In some examples, the controller is configured to determine whether the radar sensor performs the normal operation while the heating film is in operation, and stop the operation of the heating film based on the radar sensor performs the normal operation.

In some examples, the vehicle can include a controller configured to collect state information of the heating film and to control an operation of the heating film based on the collected information. In some implementations, the controller can be configured to determine, while the vehicle is in operation, whether the heating film performs a normal operation based on the state information of the heating film, based on determining that the heating film performs the normal operation, determine whether (i) a temperature of the heating film exceeds a preset threshold temperature or (ii) an overcurrent flows through the heating film, and stop the operation of the heating film based on determining that the temperature of the heating film exceeds the preset threshold temperature or that the overcurrent flows through the heating film.

In this application, the terms “vehicle,” “vehicular,” and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

### BRIEF DESCRIPTION OF THE DRAWINGS

The above and other features of the present disclosure will now be described in detail with reference to certain exemplary implementations thereof illustrated in the accompanying drawings which are given hereinbelow by way of illustration only, and thus are not limitative of the present disclosure.

FIG. 1 is a view showing an example of a vehicle.

FIG. 2 is a cross-sectional view of a vehicle V in the vertical direction (z), showing an example of a sensor cover mounted on the vehicle.

FIG. 3 is an exploded perspective view showing an example of the sensor cover.

FIG. 4 is an enlarged view of a region RI shown in FIG. 2.

FIG. 5 is a view showing an example of a heating film of the sensor cover.

FIG. 6 is a plan view showing an example of a heating film including heating wires arranged in a vertical pattern in the sensor cover.

FIG. 7 is a plan view showing an example of a heating film including heating wires arranged in a horizontal pattern in the sensor cover.

FIG. 8 is a view showing an example manufacturing process of the sensor cover.

FIGS. 9A, 9B, and 9C are a cross-sectional view of the sensor cover, respectively.

FIG. 10 is a cross-sectional view of the sensor cover.

FIG. 11A is a perspective view of the sensor cover.

FIG. 11B is a view showing the sensor cover viewed in the direction V1 in FIG. 11A;

FIG. 12A is a perspective view of the sensor cover.

FIG. 12B is a view showing the sensor cover viewed from the back surface along a dotted line portion shown in FIG. 12A.

FIG. 13 is a view showing a control flowchart of an example method operating the heating film in the sensor cover.

FIG. 14 is a view showing a control flowchart of an example method operating the heating film in the sensor cover.

FIG. 15 is a view showing a control flowchart of an example method operating the heating film in the sensor cover.

In the figures, reference numbers refer to the same or equivalent parts of the present disclosure throughout the several figures of the drawing.

### DETAILED DESCRIPTION

Hereinafter, one or more implementations of the present disclosure will be described in detail with reference to the attached drawings. Specific structural or functional descriptions given in connection with the implementations of the present disclosure are merely illustrative for the purpose of describing implementations according to the concept of the present disclosure, and the implementations according to the concept of the present disclosure can be implemented in various forms.

Vehicles can include a driver assistance system mounted therein and configured to assist a driver of a vehicle in order to ensure safe driving. The driver assistance system can issue a notification or a warning of lane departure or collision possibility based on detection by an environmental sensor mounted in the vehicle. In addition to the driver assistance system, technology related to autonomous vehicles (AVs) has emerged. An autonomous vehicle is capable of sensing the surrounding environment and driving without driver involvement based on detection by an environmental sensor.

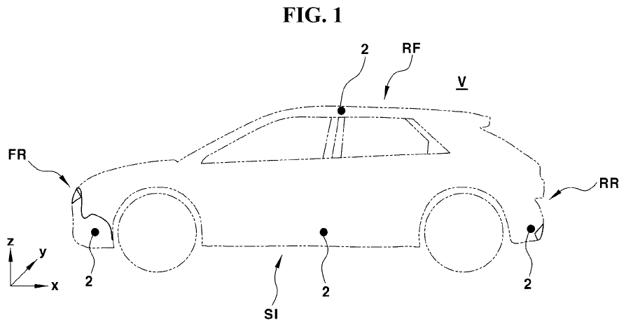

As shown in FIG. 1, a vehicle V, such as a vehicle equipped with the above-mentioned driver assistance system and an autonomous vehicle, includes one or more environmental sensors 2 mounted therein and configured to detect the surrounding environment in various ways. Examples of the environmental sensors 2 can include a radar, a LiDAR sensor, and a camera. The environmental sensors 2 can be respectively installed in various portions of the vehicle, such as the front FR, the rear RR, the roof RF, and the side SI of the vehicle. In some examples, one environmental sensor 2 is installed at each portion, but one or more environmental sensors 2 can be installed in each portion.

Each environmental sensor 2 can detect the surrounding environment in different detection methods. As a non-limiting example, the environmental sensor 2 can include a LiDAR sensor, a radar sensor, or a camera. In addition, the environmental sensor 2 can further include an ultrasonic sensor, a radio frequency identification (RFID) sensor, and the like.

The environmental sensor 2 needs to be kept clean and protected from foreign substances in order to accurately recognize the surrounding environment. Since the environmental sensor 2 is mounted in the vehicle V traveling in an outdoor environment, the environmental sensor can be exposed to flying foreign substances and the like. Further, depending on weather conditions, it can be difficult for the environmental sensor to secure a field of view due to rain, dew, frost, and the like.

Accordingly, the present disclosure describes a sensor cover capable of protecting an environmental sensor and enabling the environmental sensor to constantly perform a predetermined function thereof even in the above-mentioned situation.

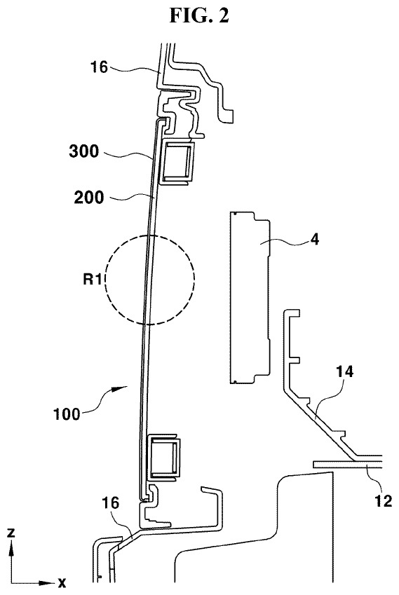

As shown in FIG. 2, in some implementations, a sensor cover 100 can be located in front of a radar sensor 4. The radar sensor 4 is configured to detect an object around the vehicle V by utilizing a millimeter wave frequency band or a microwave. Further, the radar sensor 4 is configured to assist autonomous driving or safety driving of the vehicle V based on detected information. The radar sensor 4 can be mounted on a bumper or a radiator grill to detect the surrounding environment at the front FR or the rear RR of the vehicle V. However, the installation position of the radar sensor 4 is not limited thereto. For example, the radar sensor 4 can be installed at the side SI or the roof RF of the vehicle V.

The sensor cover 100 can be disposed on the vehicle V to overlap the environmental sensor 2. In the present specification, the term “overlapping” can mean that the sensor cover 100 and the environmental sensor 2 are disposed to be adjacent to each other or to overlap each other regardless of whether the sensor cover 100 and the environmental sensor 2 are in contact with each other. For example, the sensor cover 100 can be spaced apart from the environmental sensor 2 and cover a portion of the environmental sensor 2. In some cases, the sensor cover 100 can be in contact with a portion of the environmental sensor 2.

In some implementations, the sensor cover 100 can be disposed to overlap the radar sensor 4. As shown, the sensor cover 100 can be disposed on the front FR of the vehicle, and particularly, can be mounted on a radiator grill portion of the vehicle V. For example, the radar sensor 4 can be fixed to the radiator grill portion by a mounting bracket 14 fixed to a front back beam 12 of the vehicle V. The sensor cover 100 can be disposed on the radiator grill portion in front of the radar sensor 4 and can be supported by a bumper cover 16. Recently, with the emergence of electric vehicles, the role of the radiator grill portion in conventional engine vehicles is disappearing. The sensor cover 100 can be mounted on the conventional radiator grill portion in an electric vehicle and can be disposed to protect the environmental sensor 2 or the radar sensor 4 mounted inside the sensor cover 100.

Referring to FIG. 3, in some implementations, the sensor cover 100 is configured to perform the above-described function using a base layer 200, a cover layer 300, and a heating film 400. The base layer 200 and the cover layer 300 can protect the environmental sensor 2 or the radar sensor 4 and can also protect the heating film 400 disposed between the base layer 200 and the cover layer 300. The heating film 400 is configured to generate heat under low-temperature conditions or preset conditions, thereby enabling the radar sensor 4 to secure a field of view thereof.

Each of the base layer 200 and the cover layer 300 is formed of a material that may not impede radio-wave transmission performance of the environmental sensor 2 or the radar sensor 4. In some implementations, the cover layer 300 and the base layer 200 can be formed of a transparent material. In some implementations, the cover layer 300 can be formed of a polyurethane (PU) material, and the base layer 200 can be formed of a polycarbonate (PC) material. In some examples, the cover layer 300 can be formed of polyurethane (PUR) or polyurea (PUA).

The base layer 200 and the cover layer 300 can be formed through injection molding. As described below, in some implementations, the base layer 200 and the cover layer 300 can be integrated with each other through double injection molding.

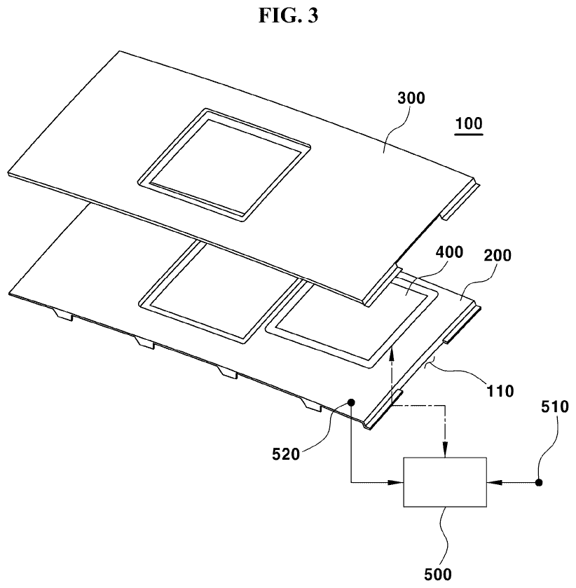

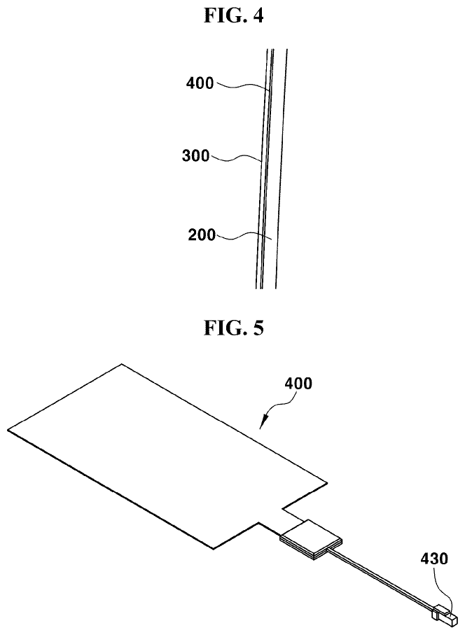

Referring to FIG. 4, the heating film 400 can be disposed between the base layer 200 and the cover layer 300. The heating film 400 can be formed as a sheet, as shown in FIG. 5 and can be disposed between the base layer 200 and the cover layer 300.

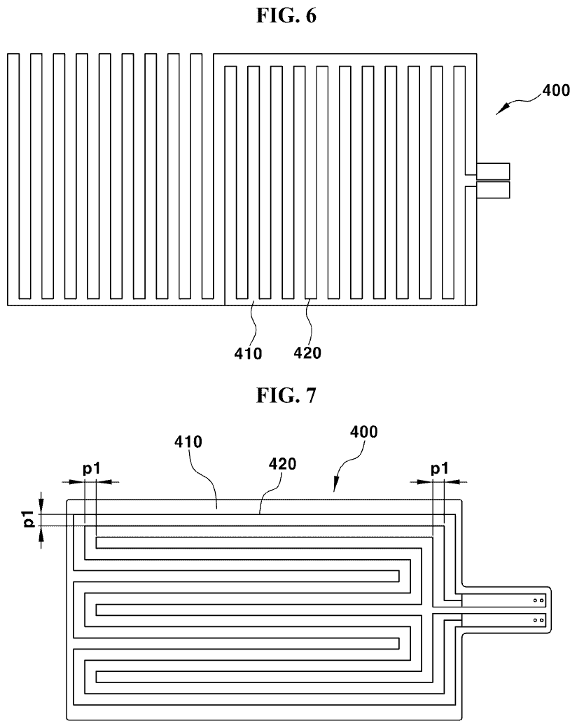

As shown in FIGS. 6 and 7, in some implementations, the heating film 400 includes a film layer 410 and heating wires 420. The heating film 400 can be prepared as a type in which the fine heating wires 420 are printed in the film layer 410. In some implementations, the film layer 410 can be formed of a polyethylene terephthalate (PET) material.

Arrangement of the heating wires 420 in the heating film 400 can be adjusted depending on set directionality of the radar sensor 4. In some implementations, as shown in FIG. 6, the heating wires 420 can be disposed in a vertical pattern. In some examples, as shown in FIG. 7, the heating wires 420 can be disposed in a horizontal pattern.

Referring to FIG. 8, the sensor cover 100 can be manufactured through an injection molding and a bonding process. Specifically, after the base layer 200 is injection molded, the heating film 400 is attached to the surface of the base layer 200. The sensor cover 100 can be manufactured by double-injection molding the cover layer 300 on the surface of the base layer 200 to which the heating film 400 is attached.

In some implementations, the sensor cover 100 can include various features of the base layer 200, the cover layer 300, and the heat film 400 such that transmission performance of the radar sensor 4 can be stably maintained under low-temperature conditions.

In some implementations, a thickness of the base layer 200 can be set to 2.6 millimeters (mm) ±10%. When the thickness of the base layer 200 is set to be smaller than 2.6 mm by 10% of 2.6 mm (i.e., less than 2.34 mm), the thickness of the base layer 200 decreases, which is disadvantageous for injection molding and can cause discrepancy in temperature of the heating film 400. In some examples, when the base layer 200 is manufactured to have a thickness exceeding +10% of 2.6 mm (i.e., exceeding 2.86 mm), the attenuation rate of a wavelength of the radar sensor 4 increases. In some implementations, radio-wave transmittance performance of the radar sensor 4 and quality of the injection can be secured through the set thickness of the base layer 200. In some implementations, the base layer 200 can further include glass fiber. It can prevent shrinkage of the base layer 200 and further improve mechanical strength and heat resistance of the base layer 200.

In some implementations, the cover layer 300 is formed of a material capable of self-healing. Specifically, when damage, such as a scratch, occurs in the cover layer 300 made of a PU material, a self-healing action of the cover layer 300 may be enabled by exposing the cover layer 300 to a temperature of about 70° C. for about 3 minutes. Therefore, the sensor cover 100 can have a self-healing function by the cover layer 300.

In some implementations, the thickness of the cover layer 300 can be 0.4 mm to 1.0 mm. When the thickness of the cover layer 300 is smaller than 0.4 mm, the self-healing function may not be properly performed. When the thickness of the cover layer 300 exceeds 1.0 mm, heat transfer by the heating film 400 decreases, and material cost and weight increase. In addition, when the thickness of the cover layer 300 exceeds 1.0 mm, there is a drawback in that the cover layer is more vulnerable to chipping-off due to an increase in a soft portion in terms of self-healing performance.

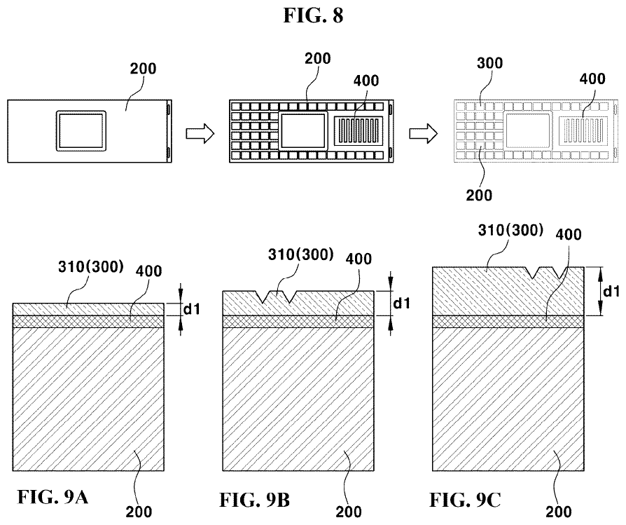

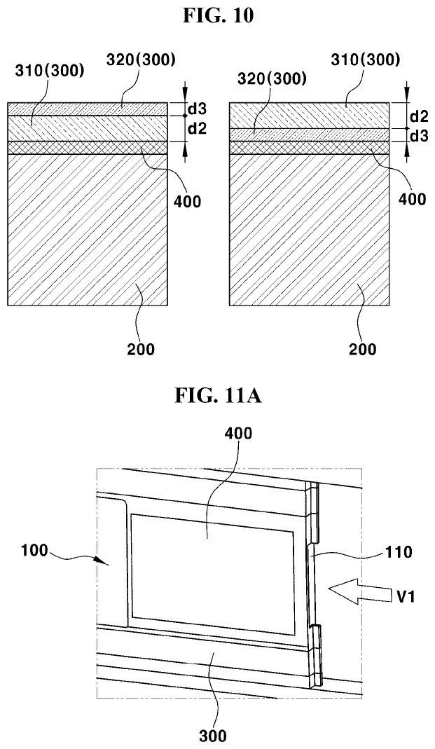

In some implementations, the hardness of the cover layer 300 can be adjusted. As shown in FIG. 9, in some implementations, the cover layer 300 can be formed of a soft layer 310. The soft layer 310 can be formed of a soft polyurethane (PU) material. In some examples, a thickness d1 of the soft layer 310 or the cover layer 300 can be 0.5 to 1.0 mm, as shown in FIG. 9B. In case where the thickness d1 of the soft layer 310 is smaller than 0.5 mm, as shown in FIG. 9A, when concentrated chipping damage occurs in the cover layer, the base layer 200 can be damaged as well because the depth of the cover layer 300 is small. In some examples, when the thickness d1 of the soft layer 300 exceeds 1.0 mm, as shown in FIG. 9C, the cover layer 300 becomes too thick, which causes an increase in material costs. In addition, when the surface of the cover layer 300 is chipped off, it can be difficult to perform a self-healing function despite the large thickness. When the cover layer 300 is formed of the soft layer 310, resilience against minor scratches can be excellent. Additionally, when the cover layer 300 is formed of the soft layer 310, the cover layer can have excellent resilience against minor scratches caused by a pencil or deep and narrow scratches caused by a knife.

As shown in FIG. 10, in some implementations, the cover layer 300 can include both the soft layer 310 and a hard layer 320. In some implementations, as shown on the left side of FIG. 10, the soft layer 310 can be disposed to contact the base layer 200, and the hard layer 320 can be disposed above the soft layer 310. In some examples, as shown on the right side of FIG. 10, the hard layer 320 can be disposed to contact the base layer 200, and the soft layer 310 can be disposed above the hard layer 320.

In some implementations, the total thickness of the soft layer 310 and the hard layer 320 can be set to 0.5 to 1.0 mm. In some implementations, a thickness d2 of the soft layer 310 can be set smaller than a thickness d3 of the hard layer 320. The hard layer 320 has the advantage of being resistant to external chipping. Further, when chipping stronger than a hardness level of 3H occurs, the soft layer 310 can be restored. When the cover layer 300 is formed of the soft layer 310 and the hard layer 320, resilience can be excellent for minor scratches. In addition, when the cover layer 300 is formed of the soft layer 310 and the hard layer 320, resilience can be excellent for minor scratches caused by a pencil or deep and narrow scratches caused by a knife. Further, the hard layer 320 is more resistant to chipping than the soft layer 310. Here, when the cover layer 300 includes the hard layer 320, the cover layer can have more resistance to chipping.

The soft layer 310 and the hard layer 320 of the cover layer 300 can be adjusted by the amount of a hardener added to the cover layer 300. For example, when the hardness of the cover layer 300 made of PU material is approximately 60 or less depending on the amount of the hardener added to the cover layer, it can be classified as the soft layer 310. Similarly, when the hardness of the cover layer 300 is approximately 80 or more depending on the amount of the hardener added thereto, it can be classified as the hard layer 320. For instance, the hardness of PU material can be measured in the Shore A scale by a durometer.

The heating film 400 can be configured to enable the radar sensor 4 to maintain transmission performance thereof even in a low-temperature environment or an extremely cold environment. In other words, the heating film 400 can improve performance of the environmental sensor 2 by implementing defogging and deicing performance. In addition, the heating film 400 can satisfy radio-wave transmission performance of the radar sensor 4. In some implementations, the heating wires can be arranged in the heating film 400 with a predetermined interval therebetween to minimize affecting radio wave transmission performance of the radar senor. In some implementations, external exposure of the heating film 400 can be minimized, thereby providing improved aesthetics in terms of design.

In some implementations, the heating wire 420 can be formed of a material containing 90% Cu and 10% Ag. However, the composition ratio can be changed depending on material costs, temperature rise conditions, and the like. As a non-limiting example, the heating wire 420 can be formed of a material containing 80% CU and 20% Ag. In another non-limiting example, the heating wire 420 can be formed of a material containing 70% CU and 30% Ag. In some implementations, the heating wire 420 can be formed as a wire having a circular cross section.

In some implementations, the thickness of the heating wire 420 can be 70 to 90 micrometers. For example, the thickness of the heating wire 420 can be 80 micrometers. The heating wire 420 having a thickness within the above-described range can have an appropriate thickness for insertion into the film layer 410. Additionally, the heating wire 420 having the corresponding thickness may not be short-circuited and may not protrude visually.

Referring again to FIG. 7, in some implementations, an interval p1 between the heating wires 420 can be 5 to 7 mm. When the interval p1 is less than 5 mm, interference of the wavelength of the radar sensor 4 can be observed. When the interval p1 exceeds 7 mm, the interval between the heating wires 420 can increase, causing non-uniform heat generation. Therefore, in order to secure uniform heating performance, such as surface heating, the interval can be set to 7 mm or less.

In some implementations, the heating temperature of the heating film 400 can be set to 60 to 75 degrees Celsius. In some implementations, the heating film 400 can be configured to operate at a preset temperature within a preset time. For example, the heating film 400 can be configured to operate at the maximum temperature of 75 degrees Celsius or less within 5 to 10 minutes after power is supplied, and the target temperature can be 60 degrees Celsius.

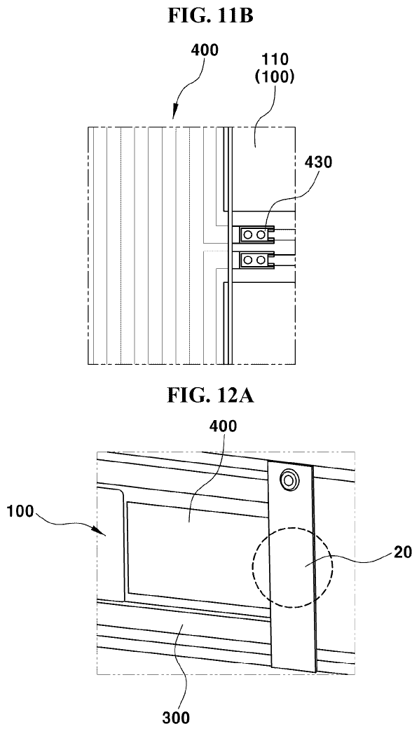

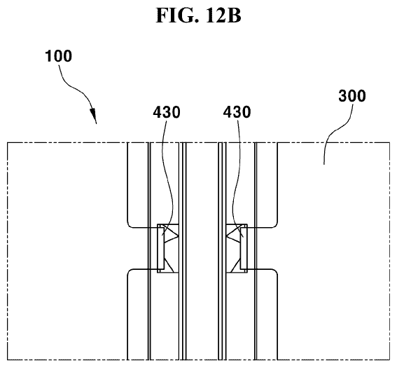

As shown in FIG. 11A, in some implementations, the sensor cover 100 can include an end region 110. The end region 110 can be recessed from the surface of the sensor cover 100. As shown in FIG. 11B, a connector 430 of the heating film 400 can be disposed in the end region 110 of the sensor cover 100, thereby providing a clean appearance. In some implementations, as shown in FIG. 12A, when a frame 20 is mounted on the sensor cover 100, the connector 430 located in the end region 110 can be disposed not to be visible from the outside. Through this structure, the sensor cover 100 can provide clean aesthetics. As shown in FIG. 12B, two sensor covers 100 can be respectively disposed at both sides of the frame 20. When viewed from the rear side of the frame 20, the connectors 430 can be arranged and stored neatly.

The sensor cover 100 may not adversely affect the aesthetics thereof by applying the heating film 400 that is not exposed to the outside. The heating film 400 can be protected from a short circuit or a disconnection due to water, other contaminants, or impact by applying insert injection to the inside of the injected base layer 200.

In addition, the sensor cover 100 may protect the environmental sensor 2 such that the environmental sensor can perform a function thereof normally under bad environmental conditions, such as rainfall, frost, and low temperature. For example, the sensor cover 100 enables the radar sensor 4 to stably maintain transmission performance thereof in a severe environment, such as a low-temperature environment or an extremely cold environment. Further, it is possible to implement a design matching the surroundings of the sensor cover 100 in a state in which the heating wires 420 are not visible from the outside by painting on the back surface of the base layer 200.

Referring back to FIG. 3, operation of the sensor cover 100 can be controlled by one or more controllers 500. One or more controllers 500 can be involved in the control of each component of the sensor cover 100. Alternatively, one or more controllers 500 can control the components of the sensor cover 100. For instance, the one or more controllers 500 can include an electric circuit, a processor, a computer, etc.

In some implementations, the controller 500 can control the operation of the heating film 400. In some implementations, the controller 500 can supply power to the heating wires of the heating film 400. The operation of the heating wires 420 can be associated with power ON and OFF by the controller 500. In some examples, the heating wires 420 can be automatically operated. In some implementations, upon determining that the radar sensor 4 is in operation, the controller 500 can operate the heating wires 420. In some examples, when an outside temperature sensor 510 detects that the temperature is below 0 degrees Celsius, the controller 500 can operate the heating wires 420. In some examples, when the vehicle V is started, the controller 500 can operate the heating wires 420.

In some examples, the controller 500 can operate the heating film 400 at a time when heating is required. In some implementations, the controller 500 is configured to communicate with the outside temperature sensor 510 configured to measure the outside temperature of the vehicle V. In some examples, the controller 500 is configured to communicate with a cover temperature sensor 520 configured to measure the surface temperature of the sensor cover 100. In some implementations, the controller 500 can also restrict the operation of the heating film 400 to prevent excessive heating of the heating film 400.

In some implementations, the controller 500 is configured to operate the sensor cover 100 according to the following control flowchart.

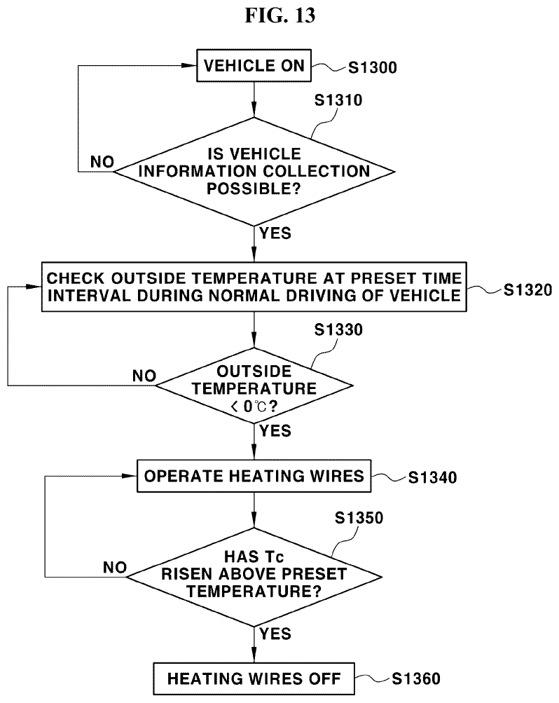

As shown in FIG. 13, the vehicle V is started at operation S1300. The controller 500 determines whether the vehicle V remains ON such that vehicle information collection is possible at operation S1310. When vehicle information collection is not possible, the process returns to operation S1300. When vehicle information collection is possible, the controller 500 is configured to check outside temperature information through the outside temperature sensor 510 at a preset time interval during normal driving of the vehicle at operation S1320. In addition, the controller 500 can collect surface temperature information of the sensor cover 100 from the cover temperature sensor 520 to collect vehicle information.

The controller 500 continuously or in real time determines, based on the received outside temperature information, whether the outside temperature is lower than 0 degrees Celsius at operation S1330. When the outside temperature is higher than 0 degrees Celsius, the controller 500 returns to operation S1320. In some examples, upon determining that the outside temperature is lower than 0 degrees Celsius, the controller 500 operates the heating film 400 at operation S1340. The operation time and the operation stop time of the heating wires can be preset. For example, the heating wire can be operated for 10 minutes and can be stopped for 3 minutes in one operation cycle.

During the operation of the heating wires, the controller 500 determines whether a surface temperature Tc of the sensor cover 100 has risen above a preset temperature at operation S1350. As a non-limiting example, the preset temperature can be 5 degrees Celsius.

When the surface temperature Tc of the sensor cover 100 has not risen above the preset temperature, the controller 500 returns to operation S1340 and operates the heating film 400. In some cases, when the surface temperature Tc of the sensor cover 100 rises above the preset temperature, the controller 500 stops the operation of the heating film 400 at operation S1360.

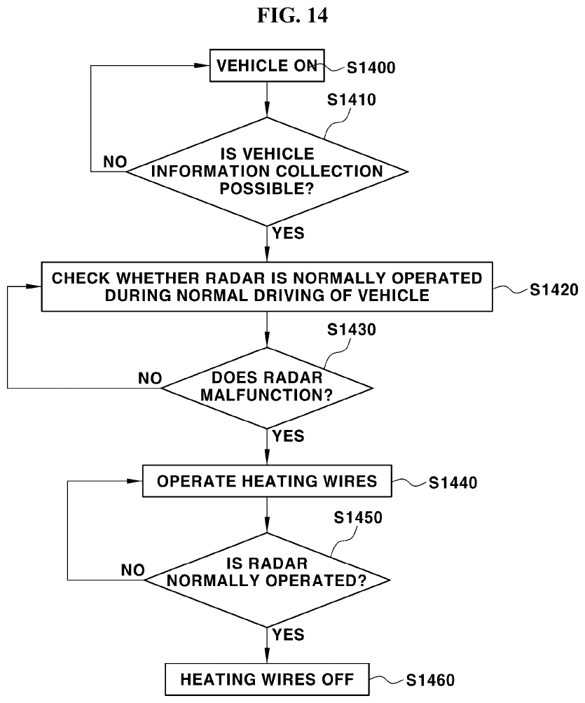

As shown in FIG. 14, in some implementations, the vehicle V is turned on at operation S1400. The controller 500 determines whether the vehicle V is kept traveling such that vehicle information collection is possible at operation S1410. When vehicle information collection is not possible, the process returns to operation S1400. When vehicle information collection is possible, the controller 500 determines whether the radar sensor 4 normally operates during normal driving of the vehicle at operation S1420. The controller 500 is configured to communicate with the radar sensor 4 to collect vehicle information, thereby collecting operation information of the radar sensor 4. For example, the controller 500 can determine that the radar sensor 4 performs a normal operation based on the transmission performance of the radar sensor 4 (e.g., power level, current, voltage, radar sensor response, transmission latency, data loss, etc.) satisfying a preset range. In addition, the controller 500 can determine that the radar sensor 4 performs an abnormal operation based on the transmission performance of the radar sensor falling outside the preset range.

The controller 500 determines whether the radar sensor 4 malfunctions based on the received operation information of the radar sensor 4 at operation S1430. Particularly, the controller 500 can determine whether the radar sensor 4 malfunctions due to surface freezing of the radar sensor based on the operation information of the radar sensor 4.

Upon determining that the radar sensor 4 malfunctions due to surface freezing of the radar sensor at operation S1440, the controller 500 operates the heating film 400. The operation time and the operation stop time of the heating film 400 can be set in advance. For example, the heating film 400 can be operated for 10 minutes and can be stopped for 3 minutes in one operation cycle.

During the operation of the heating film 400, the controller 500 collects operation information of the radar sensor 4 in real time and determines whether the radar sensor normally operates at operation S1450. Upon determining that the radar sensor 4 normally operates, the controller 500 stops the operation of the heating film 400 at operation S1460. In some examples, upon determining that the radar sensor 4 is still malfunctioning due to surface freezing, the process returns to operation S1440, and the controller 500 continues to operate the heating wires. In an example, the controller can determine that the radar sensor 4 malfunctions when there is no signal returning to the radar sensor 4 after the operation of the radar sensor 4.

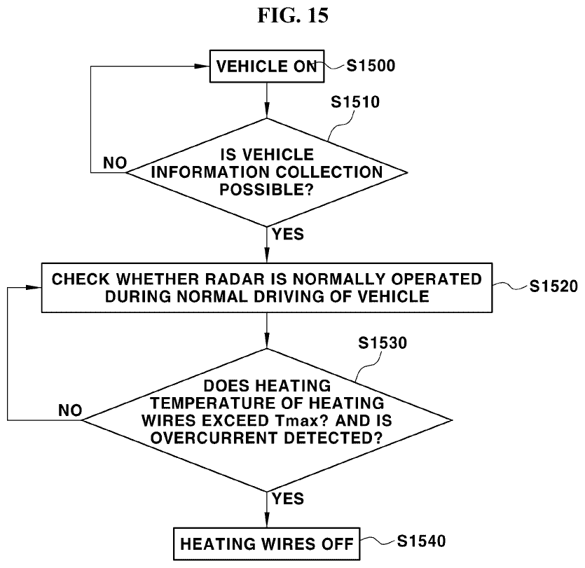

As shown in FIG. 15, in some implementations, the controller 500 can perform a control operation to prevent excessive heat generation of the heating film 400.

The vehicle V is turned on at operation S1500.

The controller 500 determines whether the vehicle V is kept ON such that vehicle information collection is possible at operation S1510. When vehicle information collection is not possible, the process returns to operation S1500. When vehicle information collection is possible, the controller 500 determines whether the heating film 400 normally operates during normal driving of the vehicle at operation S1520. The controller 500 is configured to communicate with the heating wire 420 to collect vehicle information, thereby determining whether the heating film 400 normally operates. For example, the controller 500 can determine that the heating film 400 is available to perform a normal operation based on the vehicle information indicating that a current or voltage through the heating film 400 is in a preset range. In addition, the controller 500 can determine that the heating film 400 is in an abnormal operation state based on the vehicle information indicating that the current or voltage through the heating film 400 is outside the preset range.

The controller 500 determines, based on the received operation information of the heating film 400, whether the heating temperature of the heating wires exceeds a threshold temperature (Tmax) and/or whether an overcurrent is detected at operation S1530.

When the heating temperature of the heating film 400 exceeds the threshold temperature (Tmax) or the overcurrent is detected, the controller 500 stops the operation of the heating film 400 at operation S1540. Therefore, the heating film 400 is configured to generate heat only at a set temperature or lower, thereby ensuring safety of the heating film.

The sensor cover 100 can be applied to various types of vehicles, such as sedans, sport utility vehicles (SUVs), trucks, and buses. Since the sensor cover 100 utilizes PC material which is an environmentally friendly plastic, the sensor cover can meet environmental laws and regulations.

As is apparent from the above description, the present disclosure provides a sensor cover configured to effectively protect an environmental sensor of a vehicle.

Additionally, the present disclosure provides a sensor cover configured to enable an environmental sensor of a vehicle to be normally operated in a low-temperature environment.

The effects of the present disclosure are not limited to the above-mentioned effects, and other effects not mentioned herein will be clearly understood by those skilled in the art from the detailed description of the implementations.

Although the present disclosure has been described in detail with reference to example implementations thereof, the scope of the present disclosure is not limited to the above-described implementations and the accompanying drawings, and it will be appreciated by those skilled in the art that various modifications and improvements can be made in the implementations without departing from the principles and spirit of the disclosure, the scope of which is defined in the appended claims and equivalents thereto.

What is claimed is:

1. A sensor cover comprising:
a base layer;
a cover layer disposed on the base layer and formed of a self-healing material, the cover layer being integrated with the base layer; and
a heating film disposed between the base layer and the cover layer, the heating film being configured to generate heat.

2. The sensor cover of claim 1, wherein each of the base layer and the cover layer is made of a material configured to transmit radio waves therethrough.

3. The sensor cover of claim 1, wherein the base layer is made of polycarbonate, and the cover layer is made of polyurethane.

4. The sensor cover of claim 3, wherein the base layer further comprises glass fiber.

5. The sensor cover of claim 1, wherein a thickness of the base layer is 2.34 to 2.86 millimeters (mm).

6. The sensor cover of claim 1, wherein a thickness of the cover layer is 0.4 to 1.0 mm.

7. The sensor cover of claim 1, wherein the cover layer is made of soft polyurethane or is made of soft polyurethane and hard polyurethane.

8. The sensor cover of claim 1, wherein the heating film comprises:
a film layer; and
a plurality of heating wires disposed on the film layer and spaced apart from one another by a preset interval therebetween.

9. The sensor cover of claim 8, wherein the film layer is made of polyethylene terephthalate (PET), and the plurality of heating wires are made of copper and silver.

10. The sensor cover of claim 8, wherein a thickness of each of the plurality of heating wires is 70 to 90 micrometers.

11. The sensor cover of claim 8, wherein the preset interval is 5 to 7 millimeters.

12. The sensor cover of claim 8, wherein the heating film further comprises a connector connected to the heating film and configured to supply an electrical signal to the heating film, the connector being disposed at a side surface of the sensor cover.

13. A vehicle comprising:
a radar sensor; and
a sensor cover that covers at least a portion of the radar sensor,
wherein the sensor cover comprises:
a base layer,
a cover layer disposed on the base layer and formed of a self-healing material, and
a heating film disposed between the base layer and the cover layer, the heating film being configured to generate heat.

14. The vehicle of claim 13, further comprising:
an outside temperature sensor configured to detect an outside temperature;
a cover temperature sensor configured to measure a temperature of the sensor cover; and
a controller configured to receive information from the outside temperature sensor, the cover temperature sensor, and the radar sensor, the controller being configured to control an operation of the heating film based on the collected information.

15. The vehicle of claim 14, wherein the controller is configured to:
receive the outside temperature from the outside temperature sensor while the vehicle is in operation, and
operate the heating film in response to the outside temperature being below 0 degrees Celsius.

16. The vehicle of claim 15, wherein the controller is further configured to stop the operation of the heating film in response to the temperature of the sensor cover being greater than or equal to a preset temperature.

17. The vehicle of claim 14, wherein the controller is configured to:
determine whether the radar sensor performs a normal operation while the vehicle is in operation, and
operate the heating film based on determining that the radar sensor performs an abnormal operation while the vehicle is in operation.

18. The vehicle of claim 17, wherein the controller is configured to:
determine whether the radar sensor performs the normal operation while the heating film is in operation; and
stop the operation of the heating film based on the radar sensor performs the normal operation.

19. The vehicle of claim 13, further comprising a controller configured to collect state information of the heating film and to control an operation of the heating film based on the collected information.

20. The vehicle of claim 19, wherein the controller is configured to:
determine, while the vehicle is in operation, whether the heating film performs a normal operation based on the state information of the heating film;
based on determining that the heating film performs the normal operation, determine whether (i) a temperature of the heating film exceeds a preset threshold temperature or (ii) an overcurrent flows through the heating film; and
stop the operation of the heating film based on determining that the temperature of the heating film exceeds the preset threshold temperature or that the overcurrent flows through the heating film.
